(19) United States
(12) Patent Application Publication
(10) Pub. No.: US 2004/0052961 A1
(43) Pub. Date: Mar. 18, 2004

(54) Electroless copper plating of ferrous metal substrates

(76) Inventors: Kevin Brown, Northampton (GB); Hebert Trevor Pover, Darbyshire (GB)

Correspondence Address: FULBRIGHT & JAWORSKI, LLP, 666 FIFTH AVE, NEW YORK, NY, 10103-3198, US

(21) Appl. No.: 10/451,941

(22) PCT Filed: Dec. 22, 2001
(86) PCT No.: PCT/EP01/15291

(30) Foreign Application Priority Data
Dec. 29, 2000 (GB) 0031806.3

(51) Int. Cl. B05D 1/18; C23C 18/32; C10M 101/00

(52) U.S. Cl. 427/437; 427/434.2; 427/434.6; 106/1.23; 508/150; 508/154; 508/563; 508/579; 508/583

(57) ABSTRACT

The present invention provides a continuous wire drawings process, wherein ferrous metal is drawn through multiple dies, in which the wire is coated in-line in an electroless coppering step between two wire drawing stages by being passed through a bath using transport means comprising ferrous metal components which contact solution in the bath, the bath containing an aqueous solution containing copper ions, bromide ions, a water soluble lubricant and an inhibitor compound such that a coating of copper is deposited on to the ferrous metal surface. A treatment composition as well as dry and liquid concentrate compositions are also described.

### BACKGROUND OF THE INVENTION

The present invention relates to a process for the electroless copper plating of ferrous metal substrates.

Numerous treatment methods have been proposed for forming a copper plate on metal substrates without the use of electro-coating methods. Generally, the treatment solutions used for forming copper plate on metal substrates have been aqueous acidic solutions of inorganic copper salts, such as solutions of copper sulfate, in combination with one or more additive materials which serve to enhance the deposition of the copper plate and/or the characteristics of the plate produced.

Many of the compositions and processes described in the prior art have been generally satisfactory, although some difficulties have occurred with the effect of such treatment compositions on the components of the treatment baths used to apply the copper coating to the ferrous metal substrate. Such treatments are commonly used in wire-drawing processes.

Many of the solutions utilised in be art can be extremely corrosive to the equipment used in and around the electroless copper plating process. In particular, the means for applying the metal substrate to copper or passing the metal substrate through a treatment solution are often subject to corrosion. Such means are commonly ferrous metal components and are often expensive to repair or replace, and consequently it would be desirable to minimise the corrosive effects of a coating solution on them.

U.S. Pat. No. 3,793,037 discloses a plating solution suitable for electroless copper coating on to ferrous metal surfaces, particularly steel wire. The plating solution comprises an aqueous acidic solution containing copper ions; chloride, bromide or iodide ions; a polyalkylene glycol; and a tertiary amine compound which acts as an inhibitor. The preferred treatment solutions comprise high concentrations of chloride ions. No apparatus for applying the coating treatment is disclosed.

It would be desirable to provide a treatment solution which provides copper coating on ferrous metal surfaces whilst limiting the corrosive effects of the treatment solution on the components used to apply the treatment solution.

### SUMMARY OF THE INVENTION

The present invention provides a continuous wire drawing process, wherein ferrous metal is drawn through multiple dies, in which the wire is coated in-line in an electroless coppering step between two wire drawing stages by being passed through a bath using transport means comprising ferrous metal components which contact solution in the bath, the bath containing an aqueous solution containing copper ions, bromide ions, a water soluble lubricant and an inhibitor compound such that a coating of copper is deposited on to the ferrous metal surface.

A treatment composition and concentrate compositions are also provided

### DESCRIPTION OF THE PREFERRED EMBODIMENTS

Various types of ferrous metal substrates may be treated by the process of the present invention. The process does not require the use of an electric current, and forms bright, adherent copper coatings on the ferrous metal substrates.

The process is found to be particularly useful in the treatment of steel wire, prior and/or subsequent to subjecting the wire to a drawing operation, as the copper coatings produced are found to retain their adhesion after the drawing operation.

In particular, the invention is particularly suited for the treatment of carbon steel as the wire substrate.

In a particularly preferred technique, wire to be treated by the coppering treatment is drawn through several dies and fed through the coppering solution prior to drawing or further drawing of the wire. The wire is generally fed around several pulley wheels which are immersed in the coppering solution. The pulley wheels are generally made of plastic or similar material and are mounted on ferrous metal spindles, usually stainless steel spindles. A number of such wheels, and thus spindles, are utilised in order to increase the immersion time of the wire substrate in the coppering solution. The spindles and other ferrous metal components which may be present in the working solution are subject to corrosion by the acidic coating solutions, the inventors have established that the rate and amount of corrosion is particularly sensitive to the chloride concentration in the working solution. Such ferrous metal components are commonly submerged in treatment solution for long periods, in many cases permanently, until repair is necessary of any components, or, for example, the treatment baths are cleaned out and replenished.

The metal components in the treatment baths are commonly ferrous metals and are usually made from stainless steel. The stainless steel is a passified metal substrate and is not substantially subject to coating with copper from the treatment solution. Such components are, however, subject to the corrosive nature of the treatments The spindles are usually subject to high degrees of stress due to the wire drawing process and thus are made to high specifications. Consequently their replacement and repair is expensive. Prolonging the life of the bath components, especially the spindles is particularly desirable.

Additionally, the plating solutions of the present invention may be used in any coating process wherein the presence of chloride ions is undesirable.

The working plating solutions of the present invention are aqueous acidic solutions containing copper ions, which solutions have a pH within the range of about 0 to about 3, preferably at least 0.01, more preferably within The range of about 0 to about 2, most preferably within the range of about 0.05 to about 1.5, especially within the range of about 0.2 to about 0.4.

The copper ion concentration in the treatment bath is preferably within the range of about 0.1 to about 20% by weight of the solution, more preferably in an amount within the range of about 0.2 to about 14% by weight of the solution, most preferably within the range of about 0.5 to about 4% by weight of the solution, especially within the range of about 1 to about 2% by weight of the solution. The copper ion concentration in the treatment bat is preferably above 0.3% by weight and/or below 9.2% by weight The copper ions may be incorporated in the plating solutions in any suitable form, such as copper metal, and/or various copper salts. The only requirements are whatever form of copper is used, it will produce the aqueous acidic plating solution containing the desired copper ion content, within the desired pH range, and that the ions incorporated with the copper will not have a substantial detrimental effect on either the solution and its operation, or on the quality of the copper plate which is produced.

In a preferred embodiment of the present invention, copper sulfate is used as the source of copper ions in the aqueous acidic plating solutions. Additionally, with such baths, the bath pH may be maintained within the desired range by the addition of an acid. The acid should be selected such that it provides a homogeneous pickling action of the ferrous metal substrate without causing insoluble precipitation. The acid may also contribute to the solubility of the inhibitor compound. Preferably an inorganic acid such as sulphuric acid is used.

Where the aqueous acidic plating baths used contain such sulfate ions, they are typically present in amounts within the range of about 0.1 to about 50% by weight of the solution. It is to be appreciated, of course, that other copper salts may also be used as the source of copper ions, such as copper chloride, copper bromide, copper nitrate, copper acetate, copper citrate, copper benzoate, copper metaborate, copper butyrate, copper formate, copper sulfamates, and the like, and that other acids may be used for the pH adjustment of the bath. It is to be appreciated, however, that in using such other salts or acids, particularly, those containing halide ions, care should be taken that the amounts of such latter ions, especially chloride Ions, introduced do not exceed the maximum amounts which can be present in the solution without detrimental effect.

It has been found that relatively low chloride ion concentrations in the electroless coppering solutions can lead to corrosion of the ferrous apparatus used in the wire drawing process of the present invention. Chloride ions are therefore substantially excluded from the process of the present invention. Preferably chloride ion concentrations are maintained below about 1.0 g/l, more preferably below about 0.5 g/l, more preferably below about 0.1 g/l, most preferably below about 0.05 g/l.

The applicant has found that the problems associated with the exclusion of chloride ions from electroless coppering solutions, such as poor copper costing adhesion, can be overcome by substituting chloride ions by bromide ions.

Additionally, the plating solutions of the present invention may be used in any coating process whereby the presence of chloride ions is undesirable.

Bromide ions are preferably provided by the addition to the treatment solution of a bromide salt, for example, an alkali-metal bromide, an ammonium bromide, or alkaline-earth metal bromide or mixtures thereof. Preferably sodium bromide is used. Bromide ions are present in amounts Within the range of about 0.0005 to about 5% by weight of the solution, preferably within the range of about 0.001 to about 2.5%,.mnost preferably in the range of about 0.01 to about 1%.

The water soluble lubricant is preferably selected from the group consisting of polyalkylene glycols, alkoxylated fatty acids and alkoxylated triglycerides. Preferably, where alkoxylated fatty acids and alkoxylated triglycerides are used, they are selected from ethoxylated fatty acids and ethoxylated triglycerides.

Most preferably, polyalkene glycols are used as the water soluble lubricant in the present invention and are preferably selected from polyethylene glycol, polypropylene glycol and polybutylene glycol. The polyalkylene glycol desirably has a molecular weight in excess of about 600 and preferably has a molecular weight within the range of about 1,000 to 20,000 with a more preferred range of from about 1,500 to about 10,000. Its molecular weight may preferably be above 2,500 and/or below 7,000, especially above 3,200 and/or below 5,800. Most preferably the polyalkylene glycol has a molecular weight of about 4000. Preferably the polyalkylene glycol is polyethylene glycol.

The amount of the polyalkylene glycol in the treating solutions will vary, depending upon the particular weight of the polyalkylene glycol which is used In general, it has been found that the higher the molecular weight of the polyalkene glycol, the lower is the concentration required to produce the desired results in the treating solution. Generally, the polyalkylene glycol provides cleaner, more adherent coatings than a coating solution without such a compound. Desirably, the polyalkylene glycol is present in the treating bath in amounts within the range of about 0.0005% by weight of the solution up to its saturation concentration in the bath, with amounts within the range of about 0.001 to about 1.0% by weight of the solution being preferred, the higher concentrations typically being used with the lower molecular weight materials, and vice versa.

The plating solutions of the present invention also contain at least one inhibitor compound. In a preferred embodiment of the present invention this is a tertiary amine compound of the structural formula Rₐ—N[(CH₂)ₙR′]_{b} wherein

a=0 or 1;

b=2 or 3;

a+b=3;

n=0 to 4;

R is selected from optionally substituted C₁₋₈ and optionally substituted C₂₋₈ alkenyl, wherein the optional substituent is selected from hydroxy or halogen; and,

R′ is phenyl or mono- or multi-substituted phenyl, wherein the substituent is selected from 1 or more halogen atoms, 1 or more C₁₋₈ alkyl groups and C₂₋₈ alkenyl groups.

The amine compound is an inhibitor of the copper plating treatment Without such an inhibitor, copper coatings are formed which tend to be porous and/or poorly adherent to the metal substrate being coated. The presence of such an inhibitor allows gradual buildup of a copper coating but still sufficiently quickly enough to provide an efficient in-line treatment The treated substrates have a brighter, cleaner and more adherent copper coating than in the absence of inhibitor.

The inhibitor, usually an amine compound will be present in an amount within the range of about 0.00005% by weight of the solution up to their saturation content in the solution. Preferably, amounts of the amine compound within the range of about 0.0001 to about 0.1% by weight of the solution will be used.

The amine compound is for instance, selected from the group consisting of triphenylamine, tribenzylamine, triphenethylamine, N,N,N-tris(4-phenylbutyl)amine, hydroxmethyldibenzylamine, 2-hydroxyethyldibezylamine, 4-chlorobutyldiphenylamine, 4-iodobutyldiphenylamine, 3-bromopropyldiphenylamine, mono-, di- and trimethyl-substituted triphenylamine, and mono-, di- and trichloro substituted tribenzylamine. Most preferably tribenzylamine is used as the inhibitor.

Further components may be added to the treatment solution, for example, organic solvents, pH adjusting compounds including buffers, metal ion sequestrants and corrosion inhibitors.

In a further embodiment of the present invention, a concentrate formulation is provided. Such a concentrate may be provided to the user and subsequently made up into a working solution by the addition of the concentrate to water or may be used to replenish a pre-prepared solution. Such a concentrate formulation comprises the water soluble lubricant bromide salt(s), inhibitor(s), organic solvent(s), acid(s), preferably sulphuric acid, and water. The relative amounts of these components are as follows.

The water soluble lubricant preferably polyalkylene glycol, is present in the range of about 0.5 to about 20% by weight, especially more tan 1% by weight, preferably about 2 to 15%, more preferably about 5 to 12%, most preferably in a concentration of about 10% by weight of the concentrate formulation.

Bromide salt(s), preferably alkali-metal bromide, ammonium bromide and/or alkali-earth metal bromide, more preferably alkali-metal bromide, is present in a range of about 0.01 to about 5%, preferably about 0.1 to 5%, more preferably about 0.5 to 1.5%, most preferably in a concerrtration of about 1% by weight of the concentrate formulation.

At least one inhibitor, preferably tribenzylamine, is present in a range of about 0.01 to about 2%, preferably eabout 0.1 to about 1.5% by weight of the concentrate formulation.

Organic solvent is preferably present in the range of about 0.1 to about 20%, preferably about 0.5 to about 20%, more preferably about 5 to about 10% by weight of the concentrate formulation.

Acid, preferably sulphuric acid, more preferably sulphuric acid of a concentration of 77% or 96%, is present in the range of about 0.01 to about 80%, preferably about 0.1% to about 70% by weight of the concentrate formulation.

Water is present in a range of about 5 to about 95%, preferably in a range of about 5 to about 90%, more preferably in a range of about 30 to about 85%, most preferably about 80% by weight of the concentrate formulation.

The organic solvent is preferably selected from the group consisting of alcohols, alkaneas, alkenes and ethers. The solvent is selected to dissolve the inhibitor compound in the concentrate. More preferably the organic solvent is an alcohol selected from methanol, ethanol, propanol, butanol, pentanol, hexanol and isomers thereof. Most preferably the organic solvent is ethanol.

In preferred embodiments, ratios of components in the concentrate (water soluble lubricant: bromide: inhibitor, organic solvent acid: water) is in the range 1:(0.005-0.25):(0.001-0.2):(0:25):(0.0005-50):(5-50), for instance about 10:0.1:0.02:10:0.01:80. An alternative preferred concentrate ratio is about 10:3:0.1:5:0.05:95. An alternative preferred concentrate ratio is about 2.5:0.35:0.025:1:70:26. This latter formulation allows the user to avoid frequent addition of hazardous sulphuric acid to the coating solution.

In a preferred embodiment, the concentrate formulation may be made up by dissolving the inhibitor in the organic solvent and acid. The water soluble lubricant and bromide salt are dissolved in water and the organic solvent solution is added to the aqueous solution. The concentrate diluted with water at a rate of about 10 to 25 l per 1000 l final working solution.

In an alternative embodiment, the concentrate may be supplied in dry powder or slurry form and comprises a copper salt, preferably copper sulfate, a bromide salt preferably alkali-metal bromide, inhibitor, preferably tribenzylamine, and water soluble lubricant, preferably polyalkylene glycol. By “dry” it is meant that the composition is substantially free of water. Preferably water is present in less than 1%, more preferably 0.5% a by weight of the composition.

The copper salt preferably copper sulfate, is present in the range of about 50 to about 55% by weight, preferably about 60 to 75%, most preferably in a concentration of about 70% by weight of the concentrate formulation.

Bromide salt(s), preferably alkalimetal bromide, ammonium bromide and/or alkali-earth metal bromide, more preferably alkali-metal bromide, is present in a range of about 0.01 to about 15%, preferably of about 0.1 to 15%, more preferably of about 1 to 12,%, most preferably in a concentration of about 10% by weight of the concentrate fonnulation.

Inhibitor, preferably tribenzylamine is present in a range of about 0.01 to about 2%, preferably about 0.1 to about 1.5% by weight of the concentrate formulation.

The water soluble lubricant preferably polyalkylene glycol, is preferably present in the range of about 0.5 to about 20%, preferably about 2 to about 10% by weight of the concentrate formulation.

Preferably each concentrate is diluted with distilled or deionised water to make up the working solution, the concentration of chloride ion in the water being generally less than about 0.05 g/l.

When the concentrates are used to replenish a bath of working solution, it may be necessary to add water at the same time to reach the desired bath volume. The water added at such a step should also be a low chloride content water, of less than 0.05 g/l, for instance, and is preferably distilled or deionised.

The present invention comprises electroless coppering processes in which the novel concentrates are used to make up an initial working coppering solution and/or to replenish a solution when monitoring of the composition indicates replenishment is appropriate. Replenishment with the liquid concentrate may involve separate addition of copper salt and/or acid. Replenishment with the dry or shinny concentrate may involve separate addition of acid.

In carrying out the method of the present invention, the ferrous metal surface to be treated, such as a length of steel wire, is first cleaned, using any suitable cleaning techniques. Where desired, this cleaning may include acid pickling, alkaline cleaning, and may include a combination of several of these cleaning or pre-treating steps. Preferably all such pretreatment steps should involve lower or no chloride content compositions, preferably having chloride ion content ion content of less than 0.05 g/l.

Depending upon the particular configuration of the ferrous surface to be treated, contacting techniques for the copper plating solution may be utilized such as immersion, spraying, flooding, and the like. Where the ferrous surface treated is steel wire, it has generally been found to be preferable if the wire is immersed in the copper plating bath. During the immersion of the wire in the bath, the copper plating bath of the present invention is desirably maintained at a temperature within the range of about 15° C. to 85° C. and preferably 24° C. to 60° C. and under these preferred conditions, immersion times of from about 10 seconds to 10 minutes are typical, preferably less than 60 seconds, more preferably in the range of 10 to 30 seconds. After removal from the copper plating solution, the ferrous metal surface may then be rinsed with water and dried.

When the ferrous surface treated in accordance with this process is steel wire, if desired, following the application of the electroless copper plate, a suitable lubricant may be applied to the coated wire to facilitate a subsequent drawing operation. Various lubricant materials, as are known to those in the art, such as numerous soap containing compositions, may be applied to the copper plated wire and this lubricant coating is then dried thereon. The wire may then be subjected to the desired drawing operation and it is found that following the drawing, the copper finish on the wire is very bright and uniform and shows good adhesion. Additionally, it is found that the solutions of the present invention may also be used to form a copper coating which is useful as a lubricant material for warm forming operation, as well as for a decorative copper coating.

### EXAMPLES

### Example 1

Plant Trials of Chloride Free Process for Coppering of Steel Wire.

The coppering solution was prepared as follows, whereby the following was added to 500 litres of water:

| | |
|---|---|
| Copper sulfate pentahydrate | 40 kg. |
| Concentrated sulphuric acid | 38 litres. |
| Polyethylene glycol mol. wt. 4000 | 760 g. |
| Sodium Bromide | 100 g. |
| Tribenzylamine | 8 g. |

The solution was stirred until all of the chemicals had dissolved. This solution was placed in a tank heated to 60° C., and steel wire (having a diameter of 2 to 3.5 mm) from a drawing bench was continuously fed around pulley wheels (fixed to stainless steel shafts) submerged in the solution, the total time in the tank was approximately 10 seconds. After exiting the tank the wire was rinsed and then drawn further before being wound onto spools.

After 6 months production, no stainless steel shafts had to be replaced using the above solution whereas, using the prior art chloride containing process, two shafts would have had to be replaced in the same period of time.

### Example 2

The coppering solution was prepared by adding the following chemicals to 1600 litres of water

| | |
|---|---|
| Copper sulfate pentahydrate | 80 kg. |
| Concentrated sulphuric acid | 96 litres. |
| Polyethylene glycol m. wt. 4000 | 1350 g. |
| Sodium Bromide | 177 g. |
| Tribenzylamine | 12.8 g. |

The solution was stirred until all of the chemicals had dissolved. This solution was placed in a tank heated to 58° C., and steel wire having a diameter of 0.8 to 1.2 mm was processed as for example 1. After 4 months production no stainless steel shafts had to be replaced using the above solution whereas using the prior art-chloride containing process two shafts would have had to be replaced in the same period of time. In addition whereas with the prior art process the solution would have been replaced after 40 tonnes of wire had been processed because of a deterioration in coating colour and coating weight with the new solution the bath life was increased to 70 tonnes of wire.

### Example 3

The following example illustrates the comparison in using electroless coppering treatment solutions in the presence of bromide and chloride sources. The sodium bromide examples were based on the formulation below and were substantially free of chloride ions:

| | |
|---|---|
| Copper sulfate monohydrate | 35.6 g/litre |
| 98% Sulphuric acid | 60 ml/litre |
| Demineralised water remainder. | |

Weighed stainless steel panels (type 316 alloy) were immersed in 1 litre portions of the solution which were maintained at 60° C. The panels were left in the solutions for two weeks after which they were rinsed, dried and reweighed. The results are expressed as % weight loss. Water soluble lubricant was not added to the solutions as this was not necessary to show the contrast of using bromide to chloride.

Corrosion Tests on Stainless Steel

| | | | % weight |
|---|---|---|---|
| | | | loss of |
| Sodium | % weight loss | sodium | ferrous |
| bromide g/l | of ferrous panel | chloride g/l | panel |
| Nil | 0.0% | 0.0 | 0.0% |
| 0.1 | 0.0% | 0.1 | 0.001% |
| 1.0 | 0.0% | 1.0 | 0.59% |
| 5.0 | 0.0% | 5.0 | 2.98% |
| 15.0 | 0.44% | 15.0 | 8.5% |

### Example 4

The following example is a typical concentrate formulation provided by the present invention.

| Concentrate formulation | (Parts by weight resp. weight in kg) |
|---|---|
| PEG 4000 | 90 |
| Sodium Bromide | 12 |
| Tribenzylamine | 1.7 |
| Ethanol | 90 |
| Sulphuric acid 96% | 1.0 |
| Water | 805.3 to make 1000. |

The concentrate is made up to a working solution by dissolving the tribenzylamine in the ethanol and sulphuric acid. Water (805.3 parts per weight) is then added and the polyethylene glycol and sodium bromide are dissolved. The above concentration is a specific example and it should be understood that the parts per weight given do not limit the scope of the invention to the specific quantities disclosed.

The concentrate may be presented to the customer in a ready-to-use pack preferably comprising the water soluble lubricant, inhibitor, sodium bromide and solvent. Acid is then added to the water component and then copper sulfate is dissolved. To this, the concentrate is added.

### Example 5

Instead of the concentrate formulation of Example 4, the following formulation was used:

| Concentrate formulation | (parts by weight resp. weight in kg) |
|---|---|
| 77% H₂SO₄ | 641 kg |
| Tribenzylamine | 0.36 kg |
| Ethanol | 19 kg |
| PEG 4000 | 19 kg |
| NaBr | 2.5 kg |
| H₂O | to make 1000 kg. |

Because of the higher content of sulphuric acid, instead of maintaining the strength by separate additions of the additive, sulphuric acid and copper sulfate, only copper sulfate and an additive might be used.

The formulation was as follows: The tribenzylamine (TBA) was predissolved in the ethanol and in a little part of the H₂SO₄ as mentioned in Example 4. The concentrate can be formulated stronger than with 77% H₂SO₄ and may be used in in production with medium, high or highest concentration of the acid, but as this acid could sometimes or in specific cases contain impurities that might liberate bromine if it would be made stronger than e.g. 77%, only a concentration of 77% was used here.

Similar mbdures could be used to allow for conditions on lines where the wire is processed in strands. Where the wire is processed in a coil the acid consumption may be low e.g. because of law mechanical losses and therefore the high sulphuric acid content product might be needed.

1. A continuous wire drawing process in which ferrous metal is drawn through multiple dies, in which the wire is coated inline in an electroless coppering step between two wire drawing stages by being passed through a bath using transport means comprising ferrous metal components which contact the solution in the bath, fie bath containing an aqueous solution containing copper ions, bromide ions a water soluble lubricant and an inhibitor compound such that a coating of copper is deposited onto the ferrous surface.

2. A process according to claim 1 in which the copper wire is rinsed and dried in-line immediately after the copper coating step and before the downstream wire drawing stage.

3. A process in which a ferrous metal is coated with copper in an electroless coppering process in which the metal surface is contacted with an aqueous solution comprising copper ions, bromide ions, a water soluble lubricant and an inhibitor compound, wherein the composition is substantially exclusive of chloride ions.

4. A process according to claim 3 wherein the chloride ion concentration is maintained below 1.0 g/l.

5. A process according to any preceding claim, wherein the inhibitor compound is a tertiary amine and has the general formula Rₐ—N[(CH₂)ₙR′[_{b} wherein
a=0 or 1;
b=2 or 3;
a+b=3;
n=0 to 4;
R is selected from optionally substituted C₁₋₈ alkyl and optionally substituted C₂₋₈ alkenyl, wherein the optional substituent is selected from hydroxy or halogen; and,
R′ is phenyl or mono- or multi-substituted phenyl, wherein the substituent is selected from 1 or more halogen atoms, 1 or more C₁₋₈ alkyl groups and C₂₋₈ alkenyl groups.

6. A process according to claim 3, in which the tertiary amine compound is tribenzylamine.

7. A process according to any preceding claim in which the water soluble lubricant is selected from the group consisting of polyalkylene glycols, alkoxylated fatty acids and alkoxylated triglycerides, preferably polyalkylene glycols, most preferably polyethylene glycol, preferably having a molecular weight in the range from 1,000 to 20,000.

8. A process according to any preceding claim in which, in the aqueous solution, the concentration of bromide is in the range of 0.0005 to 5% by weight of the solution.

9. A process according to any preceding claim in which, in the aqueous solution, the concentration of inhibitor is in the range from 0.00005% by weight of the solution up to about the saturation point of the inhibitor in the solution.

10. A process according to any preceding claim in which, in the aqueous solution, the concentration of copper ions is within the range of 0.1 to 20% by weight of the solution.

11. A process according to any preceding claim in which, in the aqueous solution, the pH is within the range of 0 to 3.

12. A process according to any preceding claim in which the composition of the solution is monitored and the solution is replenished as necessary by addition of a liquid concentrate consisting of:
A water soluble lubricant in the range of 0.5 to 20% by weight of the concentrate formulation;
at least one bromide salt selected from the group consisting of alkali-metal bromide, ammonium bromide and alkali-earth metal bromide, in the range of 0.01 to 5% by weight of the concentrate formulation for the content of all bromide salts;
at least one inhibitor in the range of 0.01 to 2% by weight of the concentrate formulation for the sum of all inhibitors;
organic solvent in the range of 0.1 to 20% by weight of the concentrate formulation;
acid in the range of 0.01 to 80% by weight of the concentrate formulation; and water in the range of 5 to 95% by weight of the concentrate formulation.

13. A process according to claim 12 wherein the water soluble lubricant is present in the range of 2 to 15% by weight of the concentrate formulation;
at least one bromide salt selected from the group consisting of alkali-metal bromide, ammonium bromide and alkali-earth metal bromide, in the range of 0.1 to 5% by weight of the concentrate formulation for the content of all bromide salts;
an inhibitor in the range of 0.01 to 2% by weight of the concentrate formulation;
organic solvent in the range of 0.5 to 20% by weight of the concentrate formulation;
acid in the range of 0.01 to 80% by weight of the concentrate formulation; and
water in the range of 5 to 90% by weight of the concentrate formulation.

14. A process according to claim 12, wherein the water soluble lubricant is preferably polyalkylene glycol, and is preferably present in the concentration range of 5 to 12% by weight of the concentrate formulation;
the bromide salt is preferably alkali-metal bromide, and is preferably present in a concentration of 0.5 to 1.5% by weight of the concentrate formulation;
the inhibitor is preferably tribenzylamine, and is preferably present in a concentration range of 0.1 to 1.5% by weight of the concentrate formulation; and
the organic solvent is preferably ethanol, and is preferably in a concentration range of 5 to 10% by weight of the concentrate formulation;
the acid is preferably sulphuric acid, and is present in a range of about 0.01 to about 80% by weight of the concentrate formulation.

15. A process according to claim 12 in which the solution is replenished by separate addition of copper ions and for acid.

16. A process according to any of the claims 1 to 11 in which the composition of the solution is monitored and the solution is replenished as necessary by addition of a dry concentrate comprising:
a copper salt present in the range of 50 to 85% by weight of the concentrate formulation;
at least one bromide salt selected from the group consisting of alkali-metal bromide, ammonium bromide and alkali-earth metal bromide present in a range of 0.1 to 15% by weight of the concentrate for all bromide salts;
an inhibitor, present in the range of 0.01 to 2% by weight of the concentrate; and
a water soluble lubricant, present in the range of 0.5 to 20% by weight of the concentrate and, optionally, acid.

17. A concentrate formulation comprising:
A water soluble lubricant in the range of 0.5 to 20% by weight of the concentrate formulation;
at least one bromide salt selected from the group consisting of alkali-metal bromide, ammonium bromide and alkai-earth metal bromide, in the range of about 0.01 to about 5% by weight of the concentrate formulation for all bromide salts;
at least one inhibitor in the range of 0.01 to 2% by weight of the concentrate formulation for the sum of all inhibitors;
organic solvent in the range of 0.1 to 20% by weight of the concentrate formulation;
acid in the range of 0.01 to 80% by weight of the concentrate formulation; and
water in the range of 5 to 95% by weight of the concentrate formulation.

18. A concentrate formulation according to claim 17, wherein the water soluble lubricant is in the range of 2 to 15% by weight of the concentrate formulation;
the at least one bromide salt is selected from the group consisting of alkali-metal bromide, ammonium bromide and alkali-earth metal bromide, is in the range of about 0.1 to about 5% by weight of the concentrate formulation for all bromide salts;
the inhibitor is in the range of 0.01 to 2% by weight of the concentrate formulation;
the organic solvent is in the range of 0.5 to 20% by weight of the concentrate formulation;
the acid is in the range of 0.1 to 80% by weight of the concenfrate formulation; and
the water is in the range of 5 to 90% by weight of the concentrate formulation.

19. A concentrate formulation according to claim 17 or 18, wherein the water soluble lubricant is preferably polyalkene glycol, and is present in the concentration range of 5 to 12% by weight of the concentrate formulation;
the bromide salt is preferably alkali-metal bromide, and is preferably present in a concentration of 0.5 to 1.5% by weight of the concentrate formulation;
the inhibitor is preferably tribenzylamine, and is preferably present in a concentration range of 0.1 to 1.5% by weight of the concertrate formulation;
the organic solvent is preferably ethanol, and is preferably in a concentration range of 5 to 10% by weight of the concentrate formulation;
the acid is preferably sulphuric acid (96%), and is present in a range of 0.01 to 1% by weight of the concentrate formulation.

20. An aqueous electroless coppering solution comprising copper ions, bromide ions, a water soluble lubricant and an inhibitor compound, wherein the composition is substantially exclusive of chloride ions.

21. A solution according to claim 20, wherein the chloride ion concentration is maintained below 1.0 g/l.

22. A dry concentrate comprising:
A copper salt present in the range of 50 to 85% by weight of the concentrate formulation;
at least one bromide salt selected from the group consisting of alkali-metal bromide, ammonium bromide and alkali-earth metal bromide present in a range of 0.01 to 15% by weight of the concentrate;
an inhibitor, present in the range of 0.01 to 2% by weight of the concentrate; and
a water soluble lubricant, present in the range of 0.5 to 20% by weight of the concentrate.

23. A dry concentrate according to claim 225 wherein the copper salt is present in the range of 50 to 85% by weight of the concentrate formulation;
at least one bromide salt selected from the group consisting of alkali-metal bromide, ammonium bromide and alkali-earth metal bromide present in a range of 0.1 to 15% by weight of the concentrate;
the inhibitor is present in the range of 0.01 to 2% by weight of the concentrate; and
the water soluble lubricant is present in the range of 0.5 to 20% by weight of the concentrate.

24. A pack comprising a concentrate according to claim 22 or 23, additionally comprising as a separate component an aqueous acidic solution.

25. A process for the production of a concentrate formulation according to any of the claims 17 to 19, comprising the steps of
(a) dissolving the inhibitor in the organic solvent and acid;
(b) dissolving the water soluble lubricant and bromide salt in water; and
(c) adding (a) to (b).

26. A process of electroless coppering in which an aqueous coppering solution is made up by diluting a concentrate according to any of the claims 17 to 19 with water and adding a copper salt in an amount to produce a copper ion concentration of 0.1 to 20% by weight of the solution.

27. A pros of electroless coppering in which an aqueous coppering solution is made up by diluting a dry concentrate according to claim 22 or 23 with water and adding an acid to form a solution as defined in any of claims 3 to 11.
